(19) United States
(12) Patent Application Publication
(10) Pub. No.: US 2025/0247260 A1
(43) Pub. Date: Jul. 31, 2025

(54) Dynamic Energy as a Service Provider Capacity Licensing

(71) Applicant: Cisco Technology, Inc., San Jose, CA (US)

(72) Inventors: Ravi Chandra, Saratoga, CA (US); Pradeep K. Kathail, Los Altos, CA (US); Eric A. Voit, Bethesda, MD (US)

(21) Appl. No.: 18/427,804

(22) Filed: Jan. 30, 2024

(51) Int. Cl. H04L 12/10; H04L 12/12

(52) U.S. Cl. CPC H04L 12/10; H04L 12/12

(57) ABSTRACT

Devices, systems, methods, and processes for transmitting power and managing power transmission are described herein. A device may be configured to transmit power to multiple user devices. The device can receive, from a licensing server, a power utilization license indicative of a power consumption threshold. The device can transmit power to the user devices based on the power utilization license. The device may monitor a power consumption of the user devices. The device can identify a license gap based on a difference in measured power consumption of the user devices and the power consumption threshold. The device may transmit a signed utilization signal indicative of the measured power consumption and the license gap. The licensing server can provide a temporary power utilization license by way of a synchronization response signal. The device can thereby transmit power to the one or more user devices based on the temporary power utilization license.

The present disclosure relates to power transmission. More particularly, the present disclosure relates to dynamic licensing in power transmission.

### BACKGROUND

In smart buildings, Class 4 Fault Managed Power (FMP) systems can be utilized to provide DC power. Such FMP systems can include transmitters that connect to AC power supply. The transmitters may include AC-to-DC converters or rectifiers, voltage converters, and other safety mechanisms. Due to ease of delivering DC power to user devices, FMP systems are gaining increased popularity. However, widespread adoption of FMP systems may encounter a significant hurdle if deployment of necessary infrastructure necessitates an upfront payment for all power delivery equipment by a building owner. Such a financial burden associated with this requirement could potentially slow down the adoption of smart building technologies, thereby hindering a realization of their full potential.

Currently, most building owners are forced to over invest in the power delivery equipment. Moreover, the current power delivery systems do not facilitate monitoring usage of the power delivery equipment. As a result, it is difficult for the building owners to fully realize the potential of the power delivery equipment installed in the smart buildings. Further, the current FMP systems cannot be tailored to suit the requirements of various usage types, for e.g. the smart buildings with low power consumption require same amounts of investments in the power delivery equipment as the smart buildings with high power consumption. This may create capital risks for the building owners, thereby discouraging them from installing the FMP systems.

Further, since the FMP systems are currently under development, protocols utilized for the power delivery are likely to evolve over the time. Therefore, the power delivery equipment in the FMP systems can require periodic updates and maintenance that can be difficult to monitor or manage for the building owners. The need for periodic updates and maintenance with evolving protocols adds another layer of complexity, as it requires proactive management to prevent potential disruptions in the power delivery.

Therefore, there is a need for a power transmission system that can monitor utilization of power consumption and accordingly license a usage of the power delivery equipment.

### SUMMARY OF THE DISCLOSURE

Systems and methods for dynamic licensing in power transmission in accordance with embodiments of the disclosure are described herein.

In some embodiments, a power transmission logic is configured to receive a license authorization signal indicative of one or more power utilization licenses, transmit power to one or more user devices associated with the one or more power utilization licenses, monitor a power consumption of the one or more user devices, and generate a signed utilization signal indicative of the power consumption of the one or more user devices.

In some embodiments, the one or more user devices are connected to one or more ports of the device.

In some embodiments, power is transmitted to the one or more user devices through Power over Ethernet (PoE).

In some embodiments, each power utilization license of the one or more power utilization licenses is indicative of a power consumption threshold.

In some embodiments, the power consumption threshold corresponds to a peak power allowable for consumption by the one or more user devices through PoE.

In some embodiments, the power consumption threshold corresponds to a maximum power allowable for consumption in a predetermined time period by the one or more user devices through PoE.

In some embodiments, the power transmission logic is further configured to periodically transmit the signed utilization signal to a licensing server.

In some embodiments, the power transmission logic is further configured to receive a synchronization response signal from the licensing server in response to the signed utilization signal.

In some embodiments, the signed utilization signal is indicative of one or more of a cryptographic proof of freshness corresponding to the power consumption of the one or more user devices, one or more existing power utilization licenses corresponding to the device, or a license gap.

In some embodiments, the license gap is indicative of the power consumption of the one or more user devices in excess of the power consumption threshold.

In some embodiments, the synchronization response signal is indicative of one or more temporary power utilization licenses corresponding to the license gap.

In some embodiments, each temporary power utilization license of the one or more temporary power utilization licenses is indicative of a temporary power consumption threshold greater than the power consumption of the one or more user devices in excess of the power consumption threshold.

In some embodiments, the power transmission logic is further configured to transmit power to the one or more user devices based on the one or more temporary power utilization licenses.

In some embodiments, a power management logic is configured to generate one or more power utilization licenses corresponding to a power consumption threshold, transmit a license authorization signal indicative of the one or more power utilization licenses, receive a signed utilization signal, and generate a synchronization response signal based on the signed utilization signal.

In some embodiments, the signed utilization signal is indicative of a license gap corresponding to a power consumption in excess of the power consumption threshold.

In some embodiments, the power management logic is further configured to generate one or more temporary power utilization licenses corresponding to a temporary power consumption threshold greater than the power consumption in excess of the power consumption threshold based on the license gap.

In some embodiments, the power management logic is further configured to generate the synchronization response signal indicative of the one or more temporary power utilization licenses.

In some embodiments, a license authorization signal indicative of one or more power utilization licenses is received; power is transmitted to one or more user devices associated with the one or more power utilization licenses, a power consumption of the one or more user devices is monitored, a signed utilization signal indicative of the power consumption of the one or more user devices is transmitted, a synchronization response signal is received, and power is transmitted to the one or more user devices based on the synchronization response signal.

In some embodiments, a cut off signal is received, and power transmission is terminated to the one or more user devices based on the cut off signal.

In some embodiments, historic power consumption data is received from one or more air-gaped user devices, and the signed utilization signal is generated based on the historic power consumption data.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic block diagram of a power management system, in accordance with various embodiments of the disclosure;

FIG. 2 is a schematic block diagram of a call flow in a power management system, in accordance with various embodiments of the disclosure;

FIG. 3 is a conceptual network diagram of various environments that a power manager may operate on a plurality of network devices, in accordance with various embodiments of the disclosure;

FIG. 4 is a flowchart depicting a process for generating power utilization licenses, in accordance with various embodiments of the disclosure;

FIG. 5 is a flowchart depicting a process for generating a synchronization response signal, in accordance with various embodiments of the disclosure;

FIG. 6 is a flowchart depicting a process for generating a synchronization response signal, in accordance with various embodiments of the disclosure;

FIG. 7 is a flowchart depicting a process for managing power transmission, in accordance with various embodiments of the disclosure; and

FIG. 8 is a conceptual block diagram of a device suitable for configuration with a power transmission logic and a power management logic, in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein to transmit power and to manage power transmission. In many embodiments, a power management system may include one or more devices configured to transmit power. The devices can be connected to an AC power supply and can be configured to transmit DC power. Examples of the devices may include, but are not limited to, network devices such as switches. A device can comprise multiple ports connected to multiple user devices. Each port may be coupled with one or more user devices by way of a wired connection. The device can transmit power to the user devices by way of Power over Ethernet (PoE). In some embodiments, for example, the device may utilize one or more Class 4 Fault Managed Power (FMP) protocols to transmit power to the user devices. Examples of the user devices may include, but are not limited to, computers, printers, air conditioning systems, lighting fixtures, etc. The user devices can receive DC power from the ports of the device through PoE. Each user device and each type of user device may have different power requirements. Therefore, the device may transmit an amount of power or may transmit power at a level that may be determined based on the power requirements of each user device connected to each port. Consequently, the device can transmit a right amount of power at each port as is required by corresponding user device connected to the port, thereby minimizing loss of power in form of heat and/or radiation.

In a number of embodiments, the device can receive a license authorization signal from a licensing server. The device may be connected to the licensing server by way of wired and/or wireless networks. In some embodiments, for example, the licensing server can be a cloud server. In certain embodiments, for example, the licensing server may be managed by an equipment provider that manages the device. The licensing server can be capable of receiving real-time or near-real-time telemetry data from the device. The telemetry data may be indicative of one or more of: real-time or near-real-time power consumptions of the user devices, fluctuations in AC power received by the devices, power loss at the devices, faults detected by the devices, or other such data related to power transmission or device management. The licensing server may be configured to generate one or more power utilization licenses. In further embodiments, for example, the licensing server can generate the one or more power utilization licenses based on characteristics of the device or the user devices. In many more embodiments, for example, the licensing server may generate the one or more power utilization licenses based on the real-time or near-real-time telemetry data received from the devices. In many additional embodiments, for example, the licensing server can retrieve the one or more power utilization licenses stored in a licensing software manager. In many further embodiments, the one or more power utilization licenses may be provided by an operator of the licensing server. In more embodiments, the one or more power utilization licenses can be indicative of one or more digital agreements or smart contracts that can control power transmission by the device. The license authorization signal can be indicative of the one or more power utilization licenses. In some more embodiments, for example, the license authorization signal may function as a permission for the device to transmit power to the user devices. Each power utilization license of the one or more power utilization licenses can be indicative of a power consumption threshold. In numerous embodiments, the power consumption threshold may correspond to a peak power allowable for consumption by the one or more user devices through PoE. In certain embodiments, the power consumption threshold can correspond to a maximum power allowable for consumption in a predetermined time period by the one or more user devices through PoE. The predetermined time period may be expressed in weeks, days, or months, for example. The power consumption threshold may be indicated in terms of values expressed in Watt (W) or Kilowatt hours (kWh). The power consumption threshold can be utilized to ensure that the device adheres to maximum power limits during peak power consumption. In still more embodiments, for example, the power consumption threshold can be different for different devices. In many additional embodiments, for example, the power consumption threshold can be dynamically changed or modified by the licensing server. The licensing server may change or modify the power consumption threshold based on the real-time or near-real-time telemetry data or dynamic changes to a topology of a network in which the device is connected. Examples of dynamic changes to the topology may include, but are not limited to, addition or removal of user devices. In still further embodiments, for example, the licensing server may provide time-based limitations to a peak power consumption allowable for every device or user device, thereby restricting cumulative power consumption of the devices in the network. In many more embodiments, for example, the power consumption threshold can be changed, modified, or provided by the operator of the licensing server. In additional embodiments, for example, every power utilization license may be indicative of a different power consumption threshold.

In many further embodiments, the device may transmit power to the user devices associated with the one or more power utilization licenses. The device can monitor a power consumption of the user devices. The device may generate a signed utilization signal indicative of the power consumption of the user devices. In some embodiments, the signed utilization signal may include a digital signature or an authentication mark to provide evidence of the power consumed by the device or the power transmitted to the user devices connected to the device. In certain embodiments, the signed utilization signal may also be indicative of power losses at the device or the ports of the device, or the power losses during transmission. In more embodiments, for example, the licensing server can provide flexibility to the operator to include the power losses in the power consumption threshold, or to exclude the power losses from the power consumption threshold. That is, the signed utilization signal may function as a verifiable record of one or more time-based power consumption patterns of the device or the user devices. In numerous embodiments, for example, the signed utilization signal can include one or more power quality parameters related to power quality measurement of the AC power supply. Examples of the power quality parameters include, but are not limited to, voltage, current, or frequency harmonics of the AC power supply. In many further embodiments, the signed utilization signal may include additional power quality parameters, such as but not limited to, voltage, current frequency, and waveform of an AC signal supplied by the AC power supply. In still more embodiments, the signed utilization signal may include even more power quality parameters, such as but not limited to, total harmonic distortion, active/reactive/apparent power, active/reactive/apparent energy related to the AC power supply.

In some more embodiments, the licensing server may include Artificial Intelligence (AI) or Machine Learning (ML) techniques to learn or identify one or more power consumption patterns of the device or the user devices connected to the device. The licensing server can further modify the one or more power utilization licenses based on the identified power consumption patterns. In numerous embodiments, the device can periodically transmit the signed utilization signal to the licensing server. The device may also transmit the signed utilization signal to the licensing server upon detecting or identifying a fault, a change in the topology of the network, or a sudden change (such as a surge or spike) in the power consumption. The signed utilization signal may further be indicative of a cryptographic proof of freshness corresponding to the power consumption of the one or more user devices. In many further embodiments, the cryptographic proof of freshness can be tested, i.e., cryptographically verified by the licensing server to establish authenticity of the measured power consumption. The cryptographic proof of freshness can be an externally provided cryptographic proof, a hardware-based cryptographic proof, or a can be a cryptographically signed value. The cryptographic proof of freshness may be indicative of the authenticity of a time (or epoch) of measurement of the power consumption. In some embodiments, the cryptographic proof of freshness can be generated by the device based on the measured power consumption and a timestamp corresponding to the time (or the epoch) of measurement. In some more embodiments, the cryptographic proof of freshness may be generated and/or signed by a hardware component, such as but not limited to, a Hardware Security Module (HSM) within the device. In still more embodiments, the device may utilize a private key corresponding to the device and the timestamp, to generate the cryptographic proof of freshness. In still many embodiments, the device may include synchronized and trustworthy clock generators to generate a signed timestamp indicative of the epoch. In many further embodiments, the device and/or the licensing server may perform timekeeping by sharing a nonce and returning a signed nonce, which can be included in the signed utilization signal to determine the epoch. Additionally, the device may utilize a combination of the timestamp and the nonce to generate the cryptographic proof of freshness. In further embodiments, the device and the licensing server may periodically share epoch identifiers (IDs) to determine the epoch, or the time associated with the measurement of the power consumption. The signed utilization signal may also be indicative of one or more existing power utilization licenses associated with the device. The signed utilization signal may further be indicative of a license gap. The license gap can be indicative of the power consumption of the one or more user devices in excess of the power consumption threshold. In many further embodiments, for example, the license gap may be indicative of a disparity, such as over-consumption or under-consumption of power in comparison to the power consumption threshold. That is, the device may inform the licensing server if the user devices consume power in excess of the power consumption threshold, and also an extent of the excess power consumption. The device may receive a synchronization response signal from the licensing server in response to the signed utilization signal. In many embodiments, the synchronization response signal can be an acknowledgement of successfully receiving the signed utilization signal from the device. The synchronization response signal can also be indicative of one or more temporary power utilization licenses corresponding to the license gap. In still more embodiments, the one or more temporary power utilization licenses may be provided by the licensing server to ensure uninterrupted power transmission to the user devices. In many additional embodiments, the one or more temporary power utilization licenses can be revoked by the licensing server at any time. In that, the licensing server can determine the extent of the excess power consumed by the devices or the power transmitted to the user devices. The licensing server may determine a difference in an actual power consumption indicated by the signed utilization signal and the power consumption threshold. The licensing server can utilize the difference to determine whether there exists a need for generating the one or more temporary power utilization licenses for the device. Alternatively, if the licensing server detects constant over-consumption of power, the licensing server may alter the power utilization licenses associated with the device to reduce future occurrences of the license gaps. Each temporary power utilization license of the one or more temporary power utilization licenses may be indicative of a temporary power consumption threshold. The licensing server may determine the temporary power consumption threshold based on the difference in the actual power consumption indicated by the signed utilization signal and the power consumption threshold. The temporary power consumption threshold can be greater than the power consumption of the one or more user devices in excess of the power consumption threshold. In still further embodiments, for example, the temporary power consumption threshold may be adjusted by the operator of the licensing server. In more embodiments, for example, every temporary power utilization license may be indicative of a different temporary power consumption threshold. The device may transmit power to the user devices based on the one or more temporary power utilization licenses. The device can thereby transmit power to the user devices during situations of short-term spikes or short-term increased power demands, without disconnecting the user devices. The device may further receive a cut off signal from the licensing server. The device can terminate power transmission to the user devices based on the cut off signal. In many additional embodiments, the device may be connected to one or more air-gaped user devices. The air-gaped user devices can be the user devices that receive power from the device, or that have previously received power from the device, but are physically or logically isolated. Examples of the air-gaped user devices include, but are not limited to, servers or data storage devices that are logically isolated for security reasons, user devices that operate in offline modes, user devices that are temporarily disconnected/connected to the device for a short time, etc. The device may receive historic power consumption data from the one or more air-gaped user devices. The historic power consumption data may include the power transmitted by the device to the one or more air-gaped user devices, both: presently as well as previously. The historic power consumption data can also include historic power consumption trends of the user devices, both: air-gaped user devices and other user devices, over a predetermined period of time. The device can generate the signed utilization signal based on the historic power consumption data. The inclusion of the historic power consumption data into the signed utilization signal may facilitate the licensing server to learn or identify the power consumption trends in a better way.

In still many embodiments, the licensing server may include an interactive dashboard to facilitate the operator to monitor the devices. In some embodiments, for example, the interactive dashboard can provide a snapshot of licensing states, topologies, power consumption trends, device identifiers, or the telemetry data associated with the devices connected to the licensing server. The interactive dashboard can also facilitate the operator to change or modify the power utilization licenses, the temporary power utilization licenses, the power consumption thresholds, or the temporary power consumption thresholds associated with the devices and/or the user devices.

Advantageously, the power transmission system of the present disclosure can effectively transmit, monitor, and control DC power transmission to the user devices. The use of digital certificates or cryptographic proofs to generate the signed utilization signal may provide authenticity to the monitored power consumption, thereby preventing tampering or misuse of data transmitted by the device to the licensing server. The real-time or near-real-time modifications to the power utilization licenses or the temporary power utilization licenses can enable quick adaptation to changes in power consumption or changes in the network topology. The use of power utilization licenses or the temporary power utilization licenses may facilitate a greater degree of control over transmission of power to the user devices, and may also facilitate adherence to the power consumption threshold or the temporary power consumption threshold that is set for each device. Therefore, the power transmission system of the present disclosure ensures not only efficient power transmission but also accurate and secure monitoring of the power consumption over different observation periods. Further, the power management system of the present disclosure provides a robust and accountable framework for monitoring and controlling the power transmission.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.”. Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.”. An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

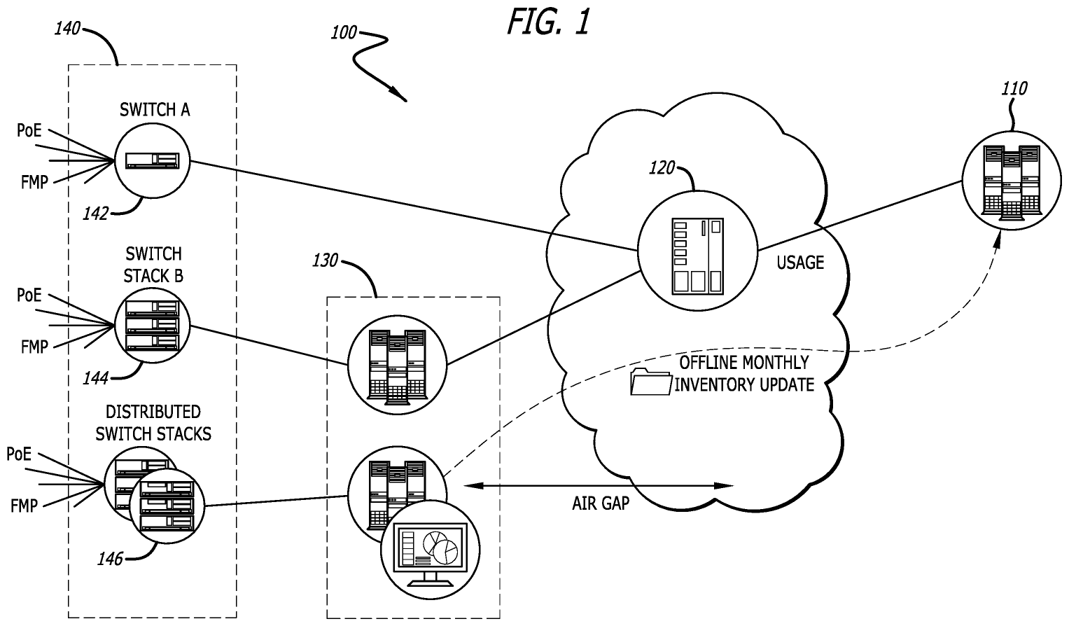

Referring to FIG. 1, a schematic block diagram of a power management system 100, in accordance with various embodiments of the disclosure is shown. In many embodiments, the power management system 100 can include a licensing software manager 110, a licensing server 120, a satellite licensing software manager 130, and a plurality of devices 140 including first through third devices 142, 144, and 146. The devices 140 may be connected to the licensing server 120 by way of wired and/or wireless networks. In some embodiments, for example, the licensing server 120 can be a cloud server. In certain embodiments, for example, the licensing server 120 may be managed by an equipment provider that manages the device. In more embodiments, one or more of the devices 140, for example, the second and third devices 144 and 146 can be connected to the licensing server 120 by way of the satellite licensing software manager 130. The satellite licensing software manager 130 may be connected to the licensing server 120 and/or the licensing software manager 110 by way of wired and/or wireless networks. In some more embodiments, for example, the third device 146 may be an air-gaped device.

In a number of embodiments, the devices 140 can be connected to an AC power supply and can be configured to transmit DC power. Examples of the devices may include, but are not limited to, network devices such as switches. Each device 140 can comprise multiple ports connected to multiple user devices. Each port may be coupled with one or more user devices by way of a wired connection. Examples of the user devices may include, but are not limited to, computers, printers, air conditioning systems, lighting fixtures, etc. The devices 140 may transmit DC power to the one or more user devices by way of Power over Ethernet (PoE). The devices 140 can utilize one or more Class 4 Fault Managed Power (FMP) protocols to transmit power to the user devices. The devices 140 may transmit real-time or near-real-time telemetry data to the licensing server 120. The telemetry data may be indicative of one or more of: real-time or near-real-time power consumptions of the user devices, fluctuations in AC power received by the devices 140, power loss at the devices 140, faults detected by the devices 140, or other such data related to power transmission or device management.

In various embodiments, the devices 140 can request for licenses to the licensing server 120 either directly or through the satellite licensing software manager 130. In some embodiments, for example, the first device 142 may directly request the licensing server 120 for a power utilization license, whereas the second and third devices 144 and 146 may request the licensing server 120 for power utilization licenses by way of the satellite licensing software manager 130. The licensing software manager 110 can store and manage one or more power utilization licenses associated with the devices 140. The licensing server 120 may be configured to generate the one or more power utilization licenses. The devices 140 can receive a license authorization signal from the licensing server 120. In further embodiments, for example, the licensing server 120 can generate the one or more power utilization licenses based on characteristics of the devices 140 or the user devices. In many more embodiments, for example, the licensing server 120 may generate the one or more power utilization licenses based on the real-time or near-real-time telemetry data received from the devices 140. In many additional embodiments, for example, the licensing server 120 can retrieve the one or more power utilization licenses stored in the licensing software manager 110. In many further embodiments, the one or more power utilization licenses may be provided by an operator of the licensing server 120. In more embodiments, the one or more power utilization licenses can be indicative of one or more digital agreements or smart contracts that can control power transmission by the devices 140. The license authorization signal may be indicative of the power utilization licenses associated with the devices 140. In some more embodiments, for example, the license authorization signal may function as a permission for the devices 140 to transmit power to the user devices.

In additional embodiments, each power utilization license of the one or more power utilization licenses can be indicative of a power consumption threshold. In numerous embodiments, the power consumption threshold may correspond to a peak power allowable for consumption by the one or more user devices through PoE. In certain embodiments, the power consumption threshold can correspond to a maximum power allowable for consumption in a predetermined time period by the one or more user devices through PoE. The predetermined time period may be expressed in weeks, days, or months, for example. The power consumption threshold may be indicated in terms of values expressed in Watt (W) or Kilowatt hours (kWh). The power consumption threshold can be utilized to ensure that the devices 140 adhere to maximum power limits during peak power consumption. In still more embodiments, for example, the power consumption threshold can be different for different devices 140. In many additional embodiments, for example, the power consumption threshold can be dynamically changed or modified by the licensing server 120. In additional embodiments, for example, every power utilization license may be indicative of a different power consumption threshold. The licensing server 120 may change or modify the power consumption threshold based on the real-time or near-real-time telemetry data or dynamic changes to a topology of a network in which the devices 140 are connected. Examples of dynamic changes to the topology may include, but are not limited to, addition or removal of user devices. In still further embodiments, for example, the licensing server 120 may provide time-based limitations to a peak power consumption allowable for every device 140 or user device, thereby restricting cumulative power consumption of the devices 140 in the network. In many more embodiments, for example, the power consumption threshold can be changed, modified, or provided by the operator of the licensing server 120.

In further embodiments, after receiving the power utilization licenses from the licensing server 120, each device 140 can transmit power to the corresponding user devices associated with corresponding power consumption licenses. The user devices can receive DC power from the ports of the devices 140 through PoE. Each user device and each type of user device may have different power requirements. Therefore, each device 140 may transmit an amount of power or may transmit power at a level that may be determined based on the power requirements of each user device connected to each port of the device 140. Consequently, each device 140 can transmit a right amount of power at each port as is required by corresponding user device connected to the port, thereby minimizing loss of power in form of heat and/or radiation.

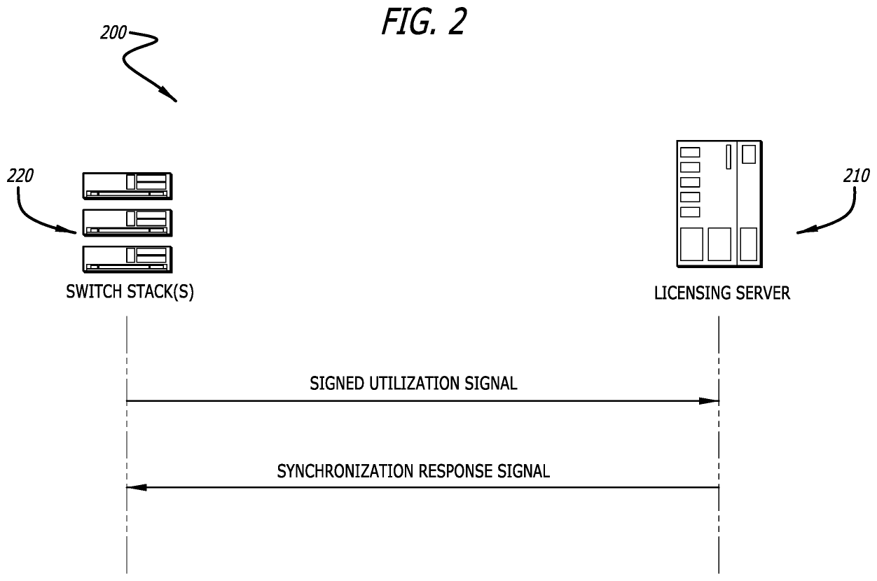

Although a specific embodiment for the power management system 100 is described above with respect to FIG. 1, any of a variety of systems and/or processes may be utilized in accordance with embodiments of the disclosure. For example, the power management system 100 may be incorporated in various network topologies including different types of interconnected devices and user devices. The elements depicted in FIG. 1 may also be interchangeable with other elements of FIGS. 2-8 as required to realize a particularly desired embodiment.

Referring to FIG. 2, a schematic block diagram of a call flow in a power management system 200, in accordance with various embodiments of the disclosure is shown. In many embodiments, the power management system 200 can include a licensing server 210 connected to one or more switch stacks 220. Initially, the switch stacks 220 may request the licensing server 210 for power utilization licenses. The licensing server 210 can generate the one or more power utilization licenses associated with the switch stacks 220. The licensing server 210 may transmit a license authorization signal to the switch stacks 220. The license authorization signal can be indicative of the one or more power utilization licenses. The license authorization signal may function as a permission for the switch stacks 220 to transmit power to the user devices. Each power utilization license of the one or more power utilization licenses can be indicative of the power consumption threshold. The switch stacks 220 may transmit power to the user devices connected to the switch stacks 220 based on the one or more power utilization licenses.

In a number of embodiments, the switch stacks 220 can monitor a power consumption of the user devices. The switch stacks 220 may generate a signed utilization signal indicative of the power consumption of the user devices. In some embodiments, the signed utilization signal may include a digital signature or an authentication mark to provide evidence of the power consumed by the switch stacks 220 or the power transmitted to the user devices connected to the switch stacks 220. In certain embodiments, the signed utilization signal may also be indicative of power losses at the switch stacks 220 or the ports of the switch stacks 220, or the power losses during transmission. In more embodiments, for example, the licensing server 210 can provide flexibility to include the power losses in the power consumption threshold, or to exclude the power losses from the power consumption threshold. That is, the signed utilization signal may function as a verifiable record of one or more time-based power consumption patterns of the switch stacks 220 or the user devices. In numerous embodiments, the switch stacks 220 can periodically transmit the signed utilization signal to the licensing server 210. The switch stacks 220 may also transmit the signed utilization signal to the licensing server 210 upon detecting or identifying a fault, a change in network topology, or a sudden change (such as a surge or spike) in the power consumption. The signed utilization signal may further be indicative of a cryptographic proof of freshness corresponding to the power consumption of the user devices. In many further embodiments, the cryptographic proof of freshness can be tested or cryptographically verified by the licensing server 210 to establish authenticity of the measured power consumption. The signed utilization signal may also be indicative of one or more existing power utilization licenses associated with the switch stacks 220. The switch stacks 220 may receive a synchronization response signal from the licensing server 210 in response to the signed utilization signal. In many embodiments, the synchronization response signal can be an acknowledgement of successfully receiving the signed utilization signal from the switch stacks 220.

Although a specific embodiment for the call flow in the power management system 200 is described above with respect to FIG. 2, any of a variety of systems and/or processes may be utilized in accordance with embodiments of the disclosure. For example, the switch stacks 220 and the licensing server 210 may utilize one or more Internet Protocols (IP) or a proprietary protocol for the call flow. The elements depicted in FIG. 2 may also be interchangeable with other elements of FIG. 1 and FIGS. 3-8 as required to realize a particularly desired embodiment.

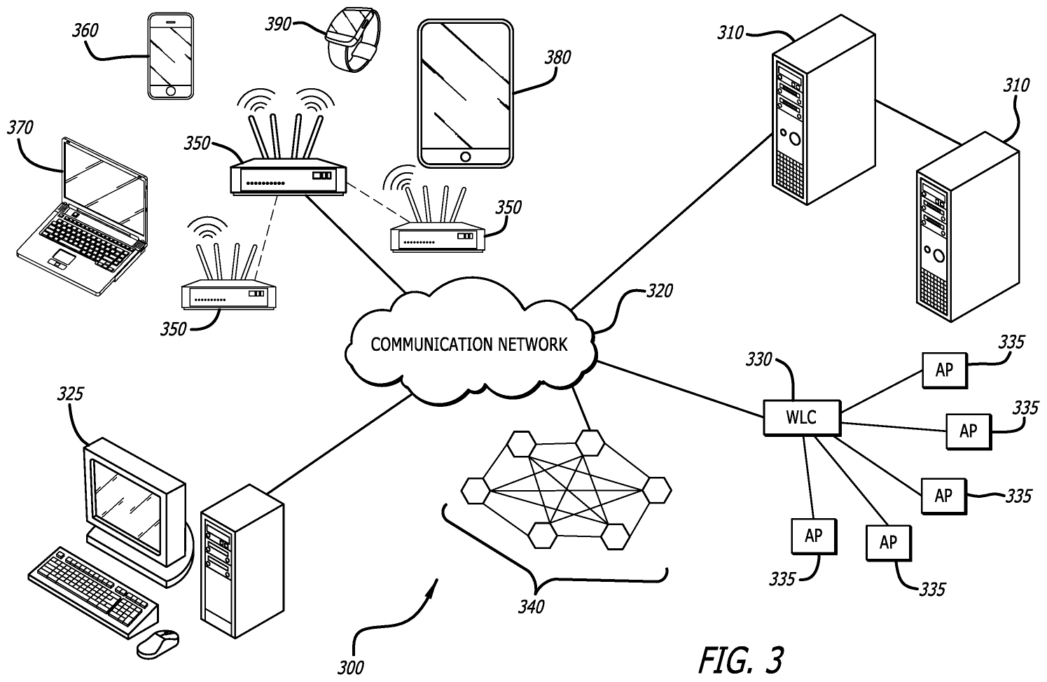

Referring to FIG. 3, a conceptual network diagram 300 of various environments that a power manager may operate on a plurality of network devices, in accordance with various embodiments of the disclosure is shown. Those skilled in the art will recognize that the power manager can include various hardware and/or software deployments and can be configured in a variety of ways. In many embodiments, the power manager can be configured as a standalone device, exist as a logic in another network device, be distributed among various network devices operating in tandem, or remotely operated as part of a cloud-based network management tool. In further embodiments, one or more servers 310 can be configured with the power manager or can otherwise operate as the power manager. In many embodiments, the power manager may operate on one or more servers 310 connected to a communication network 320. The communication network 320 can include wired networks or wireless networks. The power manager can be provided as a cloud-based service that can service remote networks, such as, but not limited to a deployed network 340. In many embodiments, the power manager can be a logic that can monitor and control power transmission and/or power consumption in the network 300.

However, in additional embodiments, the power manager may be operated as a distributed logic across multiple network devices. In the embodiment depicted in FIG. 3, a plurality of network access points (APs) 350 can operate as the power manager in a distributed manner or may have one specific device operate as the power manager for all of the neighboring or sibling APs 350. The APs 350 may facilitate Wi-Fi connections for various electronic devices, such as but not limited to, mobile computing devices including laptop computers 370, cellular phones 360, portable tablet computers 380 and wearable computing devices 390.

In further embodiments, the power manager may be integrated within another network device. In the embodiment depicted in FIG. 3, a wireless LAN controller (WLC) 330 may have an integrated power manager that the WLC 330 can use to monitor or control power consumption of the APs 335 that the WLC 330 is connected to, either wired or wirelessly. In still more embodiments, a personal computer 325 may be utilized to access and/or manage various aspects of the power manager, either remotely or within the network itself. In the embodiment depicted in FIG. 3, the personal computer 325 communicates over the communication network 320 and can access the power manager of the servers 310, or the network APs 350, or the WLC 330.

Although a specific embodiment for various environments that the power manager may operate on a plurality of network devices suitable for carrying out the various steps, processes, methods, and operations described herein is discussed with respect to FIG. 3, any of a variety of systems and/or processes may be utilized in accordance with embodiments of the disclosure. In many non-limiting examples, the power manager may be provided as a device or software separate from the WLC 330 or the power manager may be integrated into the WLC 330. The elements depicted in FIG. 3 may also be interchangeable with other elements of FIGS. 1-2 and FIGS. 4-8 as required to realize a particularly desired embodiment.

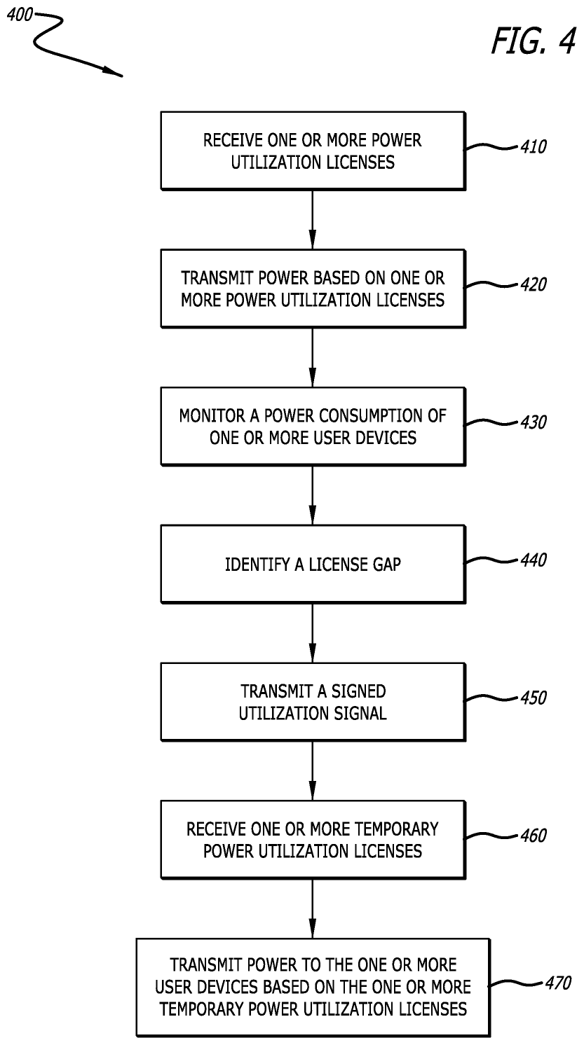

Referring now to FIG. 4, a conceptual illustration of a process 400 for generating power utilization licenses, in accordance with various embodiments of the disclosure is shown. In many embodiments, the process 400 can receive one or more power utilization licenses (block 410). In some embodiments, the process 400 may be implemented by the devices or the switch stacks, which are configured to transmit power to the user devices. In certain embodiments, the process 400 can request the licensing server for the power utilization licenses. In more embodiments, the process 400 may receive the license authorization signal from the licensing server. In some more embodiments, the license authorization signal can be indicative of the one or more power utilization licenses.

In a number of embodiments, the process 400 may transmit power based on the one or more power utilization licenses (block 420). In some embodiments, each power utilization license of the one or more power utilization licenses can be indicative of a power consumption threshold. In certain embodiments, the power consumption threshold may correspond to the peak power allowable for consumption by the one or more user devices through PoE. In more embodiments, the power consumption threshold can correspond to the maximum power allowable for consumption in the predetermined time period by the one or more user devices through PoE. In some more embodiments, the process 400 can utilize the power consumption threshold to ensure adherence to maximum power limits during peak power consumption. In that, in numerous embodiments, the process 400 can transmit power to the user devices based on the power consumption threshold indicated by the one or more power utilization licenses.

In various embodiments, the process 400 can monitor the power consumption of the one or more user devices (block 430). In some embodiments, the process 400 can detect trends or patterns of the power consumption by the user devices. In certain embodiments, the process 400 may generate the real-time or near-real-time telemetry data indicative of the power consumption of the user devices. In more embodiments, the process 400 may transmit the telemetry data to the licensing server either periodically, dynamically, in real-time, or in near-real-time.

In additional embodiments, the process 400 may identify the license gap (block 440). In some embodiments, the license gap can be indicative of the power consumption of the one or more user devices in excess of the power consumption threshold indicated by the one or more power utilization licenses. In certain embodiments, the license gap may be indicative of the disparity, such as the over-consumption or under-consumption of power in comparison to the power consumption threshold. In that, in more embodiments, the process 400 may inform the licensing server if the user devices consume power in excess of the power consumption threshold, and may also inform the extent of the excess power consumption.

In further embodiments, the process 400 can transmit the signed utilization signal (block 450). In some embodiments, the process 400 may periodically transmit the signed utilization signal to the licensing server. In certain embodiments, the process 400 may also transmit the signed utilization signal to the licensing server upon detecting or identifying a fault, a change in the topology of the network, or a sudden change (such as a surge or spike) in the power consumption. In more embodiments, the signed utilization signal may further be indicative of the cryptographic proof of freshness corresponding to the power consumption of the one or more user devices. In some more embodiments, the cryptographic proof of freshness can be tested or cryptographically verified by the licensing server to establish authenticity of the measured power consumption. In numerous embodiments, the signed utilization signal may also be indicative of the one or more existing power utilization licenses associated with the device that implements the process 400. In many further embodiments, the signed utilization signal may further be indicative of the license gap.

In many more embodiments, the process 400 may receive the one or more temporary power utilization licenses (block 460). In some embodiments, the one or more temporary power utilization licenses may be provided by the licensing server to ensure uninterrupted power transmission to the user devices. In certain embodiments, the one or more temporary power utilization licenses can be revoked by the licensing server at any time. Alternatively, in more embodiments, if the licensing server detects constant over-consumption of power, the licensing server may alter the power utilization licenses associated with the device that implements the process 400 to reduce future occurrences of the license gaps. In some more embodiments, each temporary power utilization license of the one or more temporary power utilization licenses may be indicative of the temporary power consumption threshold. In numerous embodiments, the temporary power consumption threshold can be greater than the power consumption of the one or more user devices in excess of the power consumption threshold. In many further embodiments, for example, the temporary power consumption threshold may be adjusted by the operator of the licensing server. In still more embodiments, each temporary power utilization license can correspond to a different temporary power consumption threshold.

In many additional embodiments, the process 400 can transmit power to the one or more user devices based on the one or more temporary power utilization licenses (block 470). In some embodiments, the process 400 may thereby transmit power to the user devices during situations of short-term spikes or short-term increased power demands, without disconnecting the user devices. Further, in certain embodiments, the process 400 may receive the cut off signal and may terminate power transmission to the user devices based on the cut off signal.

Although a specific embodiment for the process 400 for generating the power utilization licenses for carrying out the various steps, processes, methods, and operations described herein is discussed with respect to FIG. 4, any of a variety of systems and/or processes may be utilized in accordance with embodiments of the disclosure. In many non-limiting examples, the process 400 can dynamically alter, halt, or terminate the power transmission to the user devices based on the power utilization licenses. The elements depicted in FIG. 4 may also be interchangeable with other elements of FIGS. 1-3 and FIGS. 5-8 as required to realize a particularly desired embodiment.

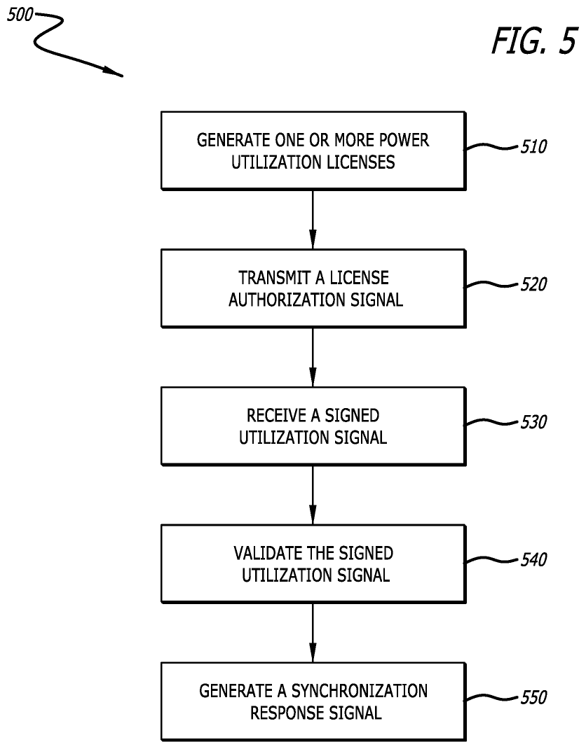

Referring now to FIG. 5, a conceptual illustration of a process 500 for generating the synchronization response signal, in accordance with various embodiments of the disclosure is shown. In many embodiments, the process 500 can generate the one or more power utilization licenses (block 510). In some embodiments, the process 500 may be implemented by the licensing server. In certain embodiments, the process 500 can receive the request from one or more devices. In more embodiments, the process 500 may generate the one or more power utilization licenses associated with the devices in response to the requests received from the devices. In some more embodiments, the process 500 can generate the one or more power utilization licenses based on characteristics of the device or the user devices. In numerous embodiments, for example, the process 500 may generate the one or more power utilization licenses based on the real-time or near-real-time telemetry data received from the devices. In many further embodiments, for example, the process 500 can retrieve the one or more power utilization licenses stored in the licensing software manager. In still more embodiments, the one or more power utilization licenses may be provided by the operator of the licensing server. In many additional embodiments, the one or more power utilization licenses can be indicative of the one or more digital agreements or smart contracts that can control power transmission by the devices.

In a number of embodiments, the process 500 may transmit the license authorization signal (block 520). In some embodiments, the license authorization signal can be indicative of the one or more power utilization licenses. In certain embodiments, for example, the license authorization signal may function as the permission for the device to transmit power to the user devices.

In various embodiments, the process 500 can receive the signed utilization signal (block 530). In some embodiments, the signed utilization signal may include the digital signature or the authentication mark to provide evidence of the power consumed by the device or the power transmitted to the user devices connected to the device. In certain embodiments, the signed utilization signal may also be indicative of power losses at the device or the ports of the device, or the power losses during transmission. That is, in more embodiments, the signed utilization signal may function as the verifiable record of one or more time-based power consumption patterns of the device or the user devices. In numerous embodiments, for example, the signed utilization signal can include one or more power quality parameters related to power quality measurement of the AC power supply. In further embodiments, examples of the power quality parameters include, but are not limited to, voltage, current, or frequency harmonics of the AC power supply. In many further embodiments, the signed utilization signal may include additional power quality parameters, such as but not limited to, voltage, current frequency, and waveform of an AC signal supplied by the AC power supply. In still more embodiments, the signed utilization signal may include even more power quality parameters, such as but not limited to, total harmonic distortion, active/reactive/apparent power, active/reactive/apparent energy related to the AC power supply.

In further embodiments, the signed utilization signal may include the cryptographic proof of freshness generated by the device. In some embodiments, the cryptographic proof of freshness can be an externally provided cryptographic proof, a hardware-based cryptographic proof, or a can be a cryptographically signed value. The cryptographic proof of freshness may be indicative of the authenticity of a time (or epoch) of measurement of the power consumption. In certain embodiments, the cryptographic proof of freshness can be generated by the device based on the measured power consumption and a timestamp corresponding to the time (or the epoch) of measurement. In some more embodiments, the cryptographic proof of freshness may be generated and/or signed by a hardware component, such as but not limited to, a Hardware Security Module (HSM) within the device. In still more embodiments, the device may utilize a private key corresponding to the device and the timestamp, to generate the cryptographic proof of freshness. In still many embodiments, the device may include synchronized and trustworthy clock generators to generate a signed timestamp indicative of the epoch. In many further embodiments, the device and/or the licensing server may perform timekeeping by sharing a nonce and returning a signed nonce, which can be included in the signed utilization signal to determine the epoch. Additionally, the device may utilize a combination of the timestamp and the nonce to generate the cryptographic proof of freshness. In further embodiments, the device and the licensing server may periodically share epoch identifiers (IDs) to determine the epoch, or the time associated with the measurement of the power consumption.

In additional embodiments, the process 500 may validate the signed utilization signal (block 540). In some embodiments, the process 500 may utilize AI or ML techniques to learn or identify the one or more power consumption patterns of the device or the user devices connected to the device. In certain embodiments, the process 500 can further modify the one or more power utilization licenses based on the identified power consumption patterns.

In further embodiments, the process 500 can generate the synchronization response signal (block 550). In some embodiments, the synchronization response signal can be the acknowledgement of successfully receiving the signed utilization signal from the device. In certain embodiments the synchronization response signal may be indicative of the successful validation of the cryptographic proof of freshness of the signed utilization signal. In more embodiments, the process 500 can transmit a separate synchronization response signal to each device in response to each signed utilization signal.

Although a specific embodiment for the process 500 for generating the synchronization response signal for carrying out the various steps, processes, methods, and operations described herein is discussed with respect to FIG. 5, any of a variety of systems and/or processes may be utilized in accordance with embodiments of the disclosure. In many non-limiting examples, the process 500 can also generate and transmit the temporary power utilization licenses by way of the synchronization response signal. The elements depicted in FIG. 5 may also be interchangeable with other elements of FIGS. 1-4 and FIGS. 6-8 as required to realize a particularly desired embodiment.

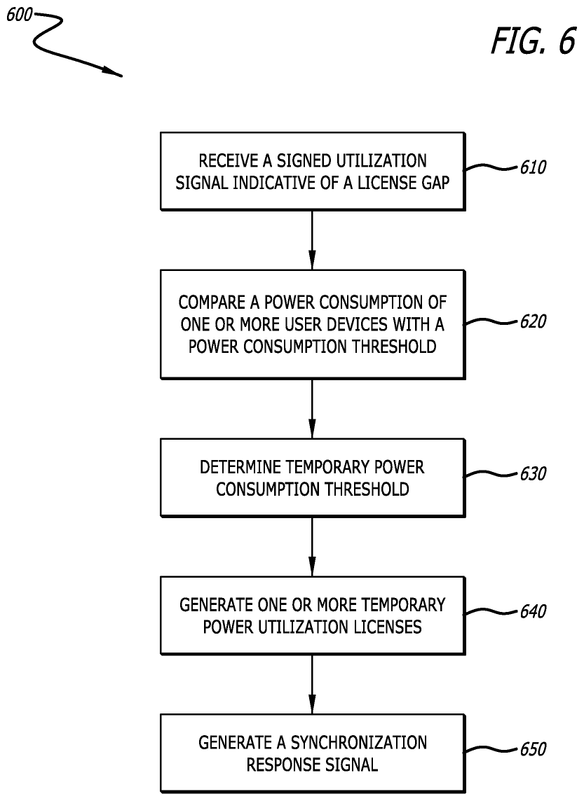

Referring now to FIG. 6, a conceptual illustration of a process 600 for generating the synchronization response signal, in accordance with various embodiments of the disclosure is shown. In many embodiments, the process 600 can receive the signed utilization signal indicative of the license gap (block 610). In some embodiments, the process 600 may be implemented by the licensing server. In certain embodiments, the license gap can be indicative of the power consumption of the one or more user devices in excess of the power consumption threshold. In more embodiments, the license gap may be indicative of a disparity, such as the over-consumption or under-consumption of power in comparison to the power consumption threshold.

In a number of embodiments, the process 600 may compare the power consumption of one or more user devices with a power consumption threshold (block 620). In some embodiments, the process 600 can determine the extent of the excess power consumed by the devices or the power transmitted to the user devices. In certain embodiments, the process 600 may determine a difference in actual power consumption indicated by the signed utilization signal and the power consumption threshold. In more embodiments, the difference can be utilized by the process 600 for determining whether there exists a need for generating the one or more temporary power utilization licenses.

In various embodiments, the process 600 can determine the temporary power consumption threshold (block 630). In some embodiments, the process 600 may determine the temporary power consumption threshold based on the difference in actual power consumption indicated by the signed utilization signal and the power consumption threshold. In certain embodiments, the temporary power consumption threshold can be greater than the power consumption of the one or more user devices in excess of the power consumption threshold. In more embodiments, for example, the temporary power consumption threshold may be adjusted by the operator of the licensing server.

In additional embodiments, the process 600 may generate the one or more temporary power utilization licenses (block 640). In some embodiments, the one or more temporary power utilization licenses may be provided by the process 600 to the devices to ensure uninterrupted power transmission to the user devices. In certain embodiments, the one or more temporary power utilization licenses can be revoked by the process 600 at any time. Alternatively, in more embodiments, if the process 600 detects constant over-consumption of power, the process 600 may alter the power utilization licenses associated with the device to reduce future occurrences of the license gaps.

In further embodiments, the process 600 can generate the synchronization response signal (block 650). In some embodiments, the synchronization response signal may be indicative of the one or more temporary power utilization licenses corresponding to the license gap. In certain embodiments, the one or more temporary power utilization licenses can be indicative of the temporary power consumption threshold. In more embodiments, every temporary power utilization license may be indicative of a different temporary power consumption threshold.

Although a specific embodiment for the process 600 for generating the synchronization response signal for carrying out the various steps, processes, methods, and operations described herein is discussed with respect to FIG. 6, any of a variety of systems and/or processes may be utilized in accordance with embodiments of the disclosure. In many non-limiting examples, the process 600 can dynamically modify or suspend the one or more temporary power utilization licenses for the devices. The elements depicted in FIG. 6 may also be interchangeable with other elements of FIGS. 1-5 and FIGS. 7-8 as required to realize a particularly desired embodiment.

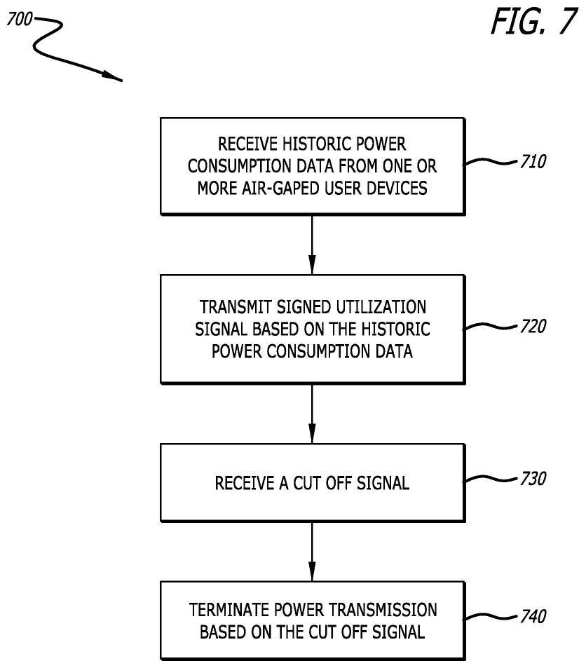

Referring now to FIG. 7, a conceptual illustration of a process 700 for managing power transmission, in accordance with various embodiments of the disclosure is shown. In many embodiments, the process 700 may receive historic power consumption data from one or more air-gaped user devices (block 710). In some embodiments, the process 700 can be implemented by the device configured to transmit power to the user devices, or can be implemented by the satellite licensing software manger. In certain embodiments, the device may be connected to one or more air-gaped user devices. In more embodiments, for example, the air-gaped user devices can be the user devices that receive power from the device, or that have previously received power from the device, but are physically or logically isolated. In some more embodiments, the examples of the air-gaped user devices may include, but are not limited to, servers or data storage devices that are logically isolated for security reasons, user devices that operate in offline modes, user devices that are temporarily disconnected/connected to the device for a short time, etc. In numerous embodiments, the process 700 may receive the historic power consumption data from such air-gaped user devices. In many further embodiments, the historic power consumption data may include the power transmitted by the device to the one or more air-gaped user devices, both: presently as well as previously. In still more embodiments, the historic power consumption data can also include historic power consumption trends of the user devices, both: air-gaped user devices and other user devices, over the predetermined period of time.

In a number of embodiments, the process 700 can transmit the signed utilization signal based on the historic power consumption data (block 720). In some embodiments, the process 700 can generate the signed utilization signal based on the historic power consumption data. In certain embodiments, the inclusion of the historic power consumption data into the signed utilization signal may facilitate the licensing server to learn or identify the power consumption trends in a better way. In more embodiments, the licensing server may store the historic power consumption data in the licensing software manager.

In various embodiments, the process 700 may receive the cut off signal (block 730). In some embodiments, the cut off signal can be indicative of terminating the power transmission to the user devices. In certain embodiments, the cut off signal may be provided to the device by the licensing server if the power utilization licenses are expired, suspended, or terminated.

In additional embodiments, the process 700 can terminate the power transmission based on the cut off signal (block 740). In some embodiments, the cut off signal can be associated with a particular device, or a particular user device connected to the device. In certain embodiments, the process 700 may terminate the power transmission only to the user device associated with the cut off signal, while continuing the power transmission to other user devices.

Although a specific embodiment for the process 700 for managing power transmission for carrying out the various steps, processes, methods, and operations described herein is discussed with respect to FIG. 7, any of a variety of systems and/or processes may be utilized in accordance with embodiments of the disclosure. In many non-limiting examples, the process 700 can provide varying degrees of control over power transmission by the devices. The elements depicted in FIG. 7 may also be interchangeable with other elements of FIGS. 1-6 and FIG. 8 as required to realize a particularly desired embodiment.

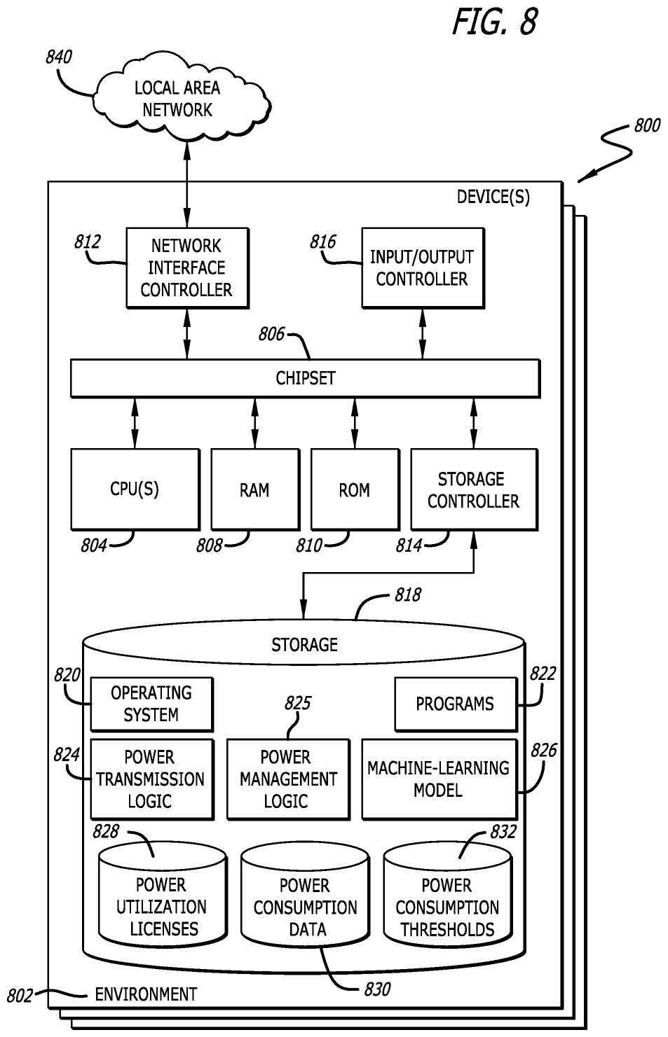

Referring to FIG. 8, a conceptual block diagram of a device 800 suitable for configuration with a power transmission logic and a power management logic, in accordance with various embodiments of the disclosure is shown. The embodiment of the conceptual block diagram depicted in FIG. 8 can illustrate a conventional server, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 8 can also illustrate an access point, a switch, or a router in accordance with various embodiments of the disclosure. The device 800 may, in many non-limiting examples, correspond to physical devices or to virtual resources described herein.

In many embodiments, the device 800 may include an environment 802 such as a baseboard or “motherboard,” in physical embodiments that can be configured as a printed circuit board with a multitude of components or devices connected by way of a system bus or other electrical communication paths. Conceptually, in virtualized embodiments, the environment 802 may be a virtual environment that encompasses and executes the remaining components and resources of the device 800. In more embodiments, one or more processors 804, such as, but not limited to, central processing units (“CPUs”) can be configured to operate in conjunction with a chipset 806. The processor(s) 804 can be standard programmable CPUs that perform arithmetic and logical operations necessary for the operation of the device 800.

In a number of embodiments, the processor(s) 804 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 806 may provide an interface between the processor(s) 804 and the remainder of the components and devices within the environment 802. The chipset 806 can provide an interface to a random-access memory (“RAM”) 808, which can be used as the main memory in the device 800 in some embodiments. The chipset 806 can further be configured to provide an interface to a computer-readable storage medium such as a read-only memory (“ROM”) 810 or non-volatile RAM (“NVRAM”) for storing basic routines that can help with various tasks such as, but not limited to, starting up the device 800 and/or transferring information between the various components and devices. The ROM 810 or NVRAM can also store other application components necessary for the operation of the device 800 in accordance with various embodiments described herein.

Additional embodiments of the device 800 can be configured to operate in a networked environment using logical connections to remote computing devices and computer systems through a network, such as the network 840. The chipset 806 can include functionality for providing network connectivity through a network interface card (“NIC”) 812, which may comprise a gigabit Ethernet adapter or similar component. The NIC 812 can be capable of connecting the device 800 to other devices over the network 840. It is contemplated that multiple NICs 812 may be present in the device 800, connecting the device to other types of networks and remote systems.

In further embodiments, the device 800 can be connected to a storage 818 that provides non-volatile storage for data accessible by the device 800. The storage 818 can, for instance, store an operating system 820, applications 822, power utilization licenses 828, power consumption data 830, and power consumption thresholds 832 which are described in greater detail below. The storage 818 can be connected to the environment 802 through a storage controller 814 connected to the chipset 806. In certain embodiments, the storage 818 can consist of one or more physical storage units. The storage controller 814 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 800 can store data within the storage 818 by transforming the physical state of the physical storage units to reflect the information being stored. The specific transformation of physical state can depend on various factors. Examples of such factors can include, but are not limited to, the technology used to implement the physical storage units, whether the storage 818 is characterized as primary or secondary storage, and the like.

In many more embodiments, the device 800 can store information within the storage 818 by issuing instructions through the storage controller 814 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 800 can further read or access information from the storage 818 by detecting the physical states or characteristics of one or more particular locations within the physical storage units.

In addition to the storage 818 described above, the device 800 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 800. In some examples, the operations performed by a cloud computing network, and or any components included therein, may be supported by one or more devices similar to device 800. Stated otherwise, some or all of the operations performed by the cloud computing network, and or any components included therein, may be performed by one or more devices 800 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 818 can store an operating system 820 utilized to control the operation of the device 800. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 818 can store other system or application programs and data utilized by the device 800.

In many additional embodiments, the storage 818 or other computer-readable storage media is encoded with computer-executable instructions which, when loaded into the device 800, may transform it from a general-purpose computing system into a special-purpose computer capable of implementing the embodiments described herein. These computer-executable instructions may be stored as application 822 and transform the device 800 by specifying how the processor(s) 804 can transition between states, as described above. In some embodiments, the device 800 has access to computer-readable storage media storing computer-executable instructions which, when executed by the device 800, perform the various processes described above with regard to FIGS. 1-7. In certain embodiments, the device 800 can also include computer-readable storage media having instructions stored thereupon for performing any of the other computer-implemented operations described herein.

In many further embodiments, the device 800 may include a power transmission logic 824 and a power management logic 825. The power transmission logic 824 and the power management logic 825 can be configured to perform one or more of the various steps, processes, operations, and/or other methods that are described above. Often, the power transmission logic 824 and the power management logic 825 can be a set of instructions stored within a non-volatile memory that, when executed by the processor(s)/controller(s) 804 can carry out these steps, etc. In some embodiments, the power transmission logic 824 and the power management logic 825 may be a client application that resides on a network-connected device, such as, but not limited to, a server, switch, personal or mobile computing device in a single or distributed arrangement. In certain embodiments, the power transmission logic 824 can facilitate transmission of DC power to the one or more user devices connected to the device 800. In more embodiments, the power management logic 825 may facilitate generation and modification of the power utilization licenses and/or the temporary power utilization licenses with the device 800 and other such devices. The power utilization licenses 828 may store the power utilization licenses and/or the temporary power utilization licenses. The power consumption data 830 can store the historic power consumption data and/or the telemetry data. The power consumption thresholds 832 may store the power consumption thresholds and/or the temporary power consumption thresholds.

In still further embodiments, the device 800 can also include one or more input/output controllers 816 for receiving and processing input from a number of input devices, such as a keyboard, a mouse, a touchpad, a touch screen, an electronic stylus, or other type of input device. Similarly, an input/output controller 816 can be configured to provide output to a display, such as a computer monitor, a flat panel display, a digital projector, a printer, or other type of output device. Those skilled in the art will recognize that the device 800 might not include all of the components shown in FIG. 8 and can include other components that are not explicitly shown in FIG. 8 or might utilize an architecture completely different than that shown in FIG. 8.

As described above, the device 800 may support a virtualization layer, such as one or more virtual resources executing on the device 800. In some examples, the virtualization layer may be supported by a hypervisor that provides one or more virtual machines running on the device 800 to perform functions described herein. The virtualization layer may generally support a virtual resource that performs at least a portion of the techniques described herein.

Finally, in numerous additional embodiments, data may be processed into a format usable by a machine-learning model 826 (e.g., feature vectors), and or other pre-processing techniques. The machine-learning (“ML”) model 826 may be any type of ML model, such as supervised models, reinforcement models, and/or unsupervised models. The ML model 826 may include one or more of linear regression models, logistic regression models, decision trees, Naïve Bayes models, neural networks, k-means cluster models, random forest models, and/or other types of ML models 826.

The ML model(s) 826 can be configured to generate inferences to make predictions or draw conclusions from data. An inference can be considered the output of a process of applying a model to new data. This can occur by learning from at least the power utilization licenses 828, the power consumption data 830, and the power consumption thresholds 832. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 826 may be generated by human/administrator verifications or may compare predicted outcomes with actual outcomes.

Although a specific embodiment for a device suitable for configuration with the power transmission logic and the power management logic for carrying out the various steps, processes, methods, and operations described herein is discussed with respect to FIG. 8, any of a variety of systems and/or processes may be utilized in accordance with embodiments of the disclosure. For example, the device 800 may be in a virtual environment such as a cloud-based network administration suite, or it may be distributed across a variety of network devices or APs. The elements depicted in FIG. 8 may also be interchangeable with other elements of FIGS. 1-7 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
a memory communicatively coupled to the processor; and
a power transmission logic, configured to:
receive a license authorization signal indicative of one or more power utilization licenses;
transmit power to one or more user devices associated with the one or more power utilization licenses;
monitor a power consumption of the one or more user devices; and
generate a signed utilization signal indicative of the power consumption of the one or more user devices.

2. The device of claim 1, wherein the one or more user devices are connected to one or more ports of the device.

3. The device of claim 2, wherein power is transmitted to the one or more user devices through Power over Ethernet (PoE).

4. The device of claim 3, wherein each power utilization license of the one or more power utilization licenses is indicative of a power consumption threshold.

5. The device of claim 4, wherein the power consumption threshold corresponds to a peak power allowable for consumption by the one or more user devices through PoE.

6. The device of claim 5, wherein the power consumption threshold corresponds to a maximum power allowable for consumption in a predetermined time period by the one or more user devices through PoE.

7. The device of claim 6, wherein the power transmission logic is further configured to periodically transmit the signed utilization signal to a licensing server.

8. The device of claim 7, wherein the power transmission logic is further configured to receive a synchronization response signal from the licensing server in response to the signed utilization signal.

9. The device of claim 8, wherein the signed utilization signal is indicative of one or more of:
a cryptographic proof of freshness corresponding to the power consumption of the one or more user devices;
one or more existing power utilization licenses corresponding to the device; or
a license gap.

10. The device of claim 9, wherein the license gap is indicative of the power consumption of the one or more user devices in excess of the power consumption threshold.

11. The device of claim 10, wherein the synchronization response signal is indicative of one or more temporary power utilization licenses corresponding to the license gap.

12. The device of claim 11, wherein each temporary power utilization license of the one or more temporary power utilization licenses is indicative of a temporary power consumption threshold greater than the power consumption of the one or more user devices in excess of the power consumption threshold.

13. The device of claim 12, wherein the power transmission logic is further configured to transmit power to the one or more user devices based on the one or more temporary power utilization licenses.

14. A device, comprising:
a processor;
a memory communicatively coupled to the processor; and
a power management logic, configured to:
generate one or more power utilization licenses corresponding to a power consumption threshold;
transmit a license authorization signal indicative of the one or more power utilization licenses;
receive a signed utilization signal; and
generate a synchronization response signal based on the signed utilization signal.

15. The device of claim 14, wherein the signed utilization signal is indicative of a license gap corresponding to a power consumption in excess of the power consumption threshold.

16. The device of claim 15, wherein the power management logic is further configured to generate one or more temporary power utilization licenses corresponding to a temporary power consumption threshold greater than the power consumption in excess of the power consumption threshold based on the license gap.

17. The device of claim 16, wherein the power management logic is further configured to generate the synchronization response signal indicative of the one or more temporary power utilization licenses.

18. A method, comprising:
receiving a license authorization signal indicative of one or more power utilization licenses;
transmitting power to one or more user devices associated with the one or more power utilization licenses;
monitoring a power consumption of the one or more user devices;
transmitting a signed utilization signal indicative of the power consumption of the one or more user devices;
receiving a synchronization response signal; and
transmitting power to the one or more user devices based on the synchronization response signal.

19. The method of claim 18, further comprising:
receiving a cut off signal; and
terminating power transmission to the one or more user devices based on the cut off signal.

20. The method of claim 19, further comprising:
receiving historic power consumption data from one or more air-gaped user devices; and
generating the signed utilization signal based on the historic power consumption data.
